(19) United States
(12) Patent Application Publication
(10) Pub. No.: US 2003/0227424 A1
(43) Pub. Date: Dec. 11, 2003

(54) Method and apparatus for in-vehicle traffic flow viewing

(76) Inventors: Marvin L. Lynch, Detroit, MI (US); Gregory N. Goestenkors, Waterfore, MI (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/164,144

(22) Filed: Jun. 5, 2002

(51) Int. Cl. G09G 5/00

(52) U.S. Cl. 345/7

(57) ABSTRACT

A vehicle (10) is equipped with one or more imaging devices (26-32) having a view external to the vehicle. The imaging devices are coupled to a monitor (54, 56, and 72) disposed within the vehicle. The imaging devices are adapted to obtain images within a field of view that may be obscured to the vehicle operator during normal operation of the vehicle. The obtained images are then displayed on the monitor.

### TECHNICAL FIELD

This patent relates to motor vehicles such as automobiles, and more particularly, this patent relates to methods and apparatus for viewing traffic flow from within a vehicle.

### BACKGROUND

A motorist's view of an approaching intersection or on backing from a parking space into an access lane is often obscured by surrounding vehicles, road signs, vegetation, buildings, fences, barriers, and the like. For example, upon reaching an intersection to a road onto which the motorist desires to turn, there may be cars parked along the side of the road that obscure the motorist's view of the lanes of traffic. To improve the view of the lanes of traffic, to determine if there are approaching vehicles, cyclists, pedestrians, and the like, the motorist may slowly pull forward into the lane of traffic. Doing so generally exposes the forward portion of the motorist's vehicle to the traffic flow within the lane potentially leading to an accident. Similarly, on backing from a parking space with vehicles parked adjacent to the motorist's vehicle, the motorist's view of the access lane is obscured. Backing into the access lane without a clear view of the traffic in the access lane is a frequent cause of parking lot fender benders.

Thus, there is a need for a method and apparatus that enhances a motorist's view of traffic flow either at an approaching intersection or parking space access lane.

### BRIEF DESCRIPTION OF THE DRAWINGS

FIG. 1 is a graphic illustration of a vehicle incorporating an embodiment of a viewing apparatus approaching an intersection having an obscured view.

FIG. 2 is a graphic depiction of a rearview mirror incorporating a monitor device for in-vehicle viewing of traffic flow.

FIG. 3 is graphic depiction of an instrument panel incorporating a monitor device for in-vehicle viewing of traffic flow.

FIG. 4 is a block diagram illustration of an embodiment of an apparatus for in-vehicle viewing of traffic flow.

FIG. 5 is a graphic illustration of a vehicle incorporating a viewing apparatus backing from a parking space into an obscured parking access lane.

FIG. 6 is a block diagram illustration of a vehicle incorporating an alternate embodiment of a viewing apparatus.

FIG. 7 is a flowchart depicting a method of viewing traffic flow.

### DETAILED DESCRIPTION

A vehicle is equipped with one or more imaging devices having a view external to the vehicle. The imaging devices are coupled to a monitor disposed within the vehicle. The imaging devices are adapted to obtain images within a field of view that may be obscured to the vehicle operator during normal operation of the vehicle. The obtained images are then displayed on the monitor. In a method of operation, the vehicle is provided with one or more imaging devices couple to an internal monitor. The imaging devices capture data along site lines that are obstructed to the vehicle operator.

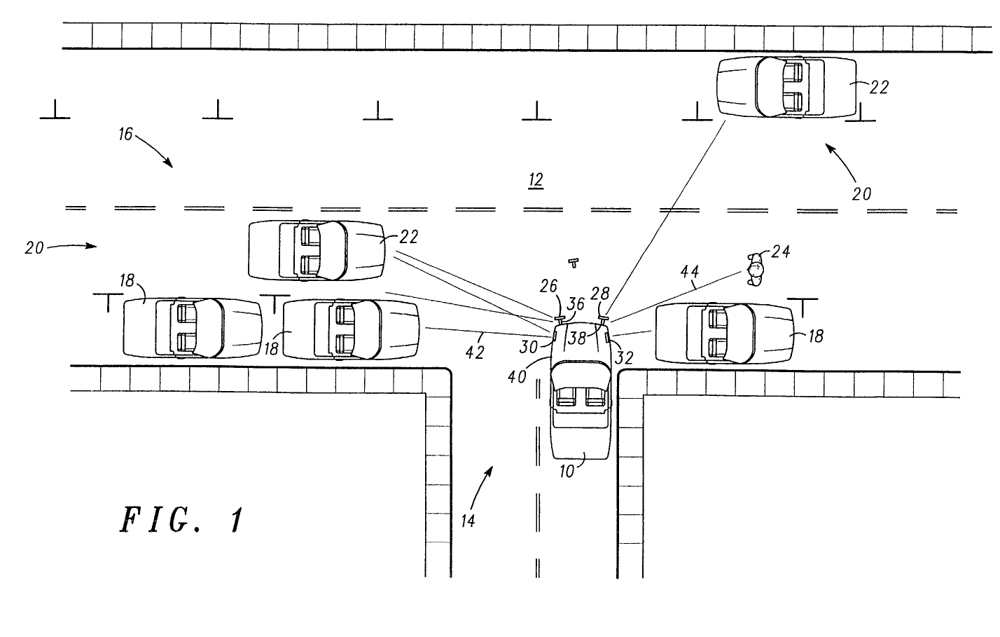

Referring to FIG. 1, a vehicle 10 is shown approaching an intersection 12 of a first road 14 and a second road 16. The vehicle 10 is shown traveling on the road 14 approaching the intersection 12. One or more obstructions obscure the vehicle operator's clear view of the traffic flow and conditions on the road 16. For example, a number of parked cars 18 are shown disposed on opposite sides of the lanes of traffic 20 on the road 16. Obstructions may be moving cars and trucks, signs, buildings, barriers, vegetation, fences and the like, and are not limited to parked cars. As a result of the obstructions, the vehicle operator's view of approaching traffic, such as cars 22 and pedestrian 24, is obscured.

The vehicle 10 is adapted to include an imaging device 26, e.g., a video camera or similar device, mounted to a forward portion 34 of the vehicle. The vehicle 10 may include several imaging devices and four imaging devices are illustrated in FIG. 1. Including imaging device 26, there is shown imaging devices 28, 30 and 32, although it is clear that the apparatus and method described are operable using a single imaging device such as imaging device 26. While throughout this discussion reference may be made in the singular to the imaging device 26, it will be appreciated that the discussion has applicability to each of the imaging devices 26-32, and others that may be described herein.

The imaging devices 26 and 28 are shown secured respectively to a mast 36 and 38 projecting from the forward portion 34, while the imaging devices 30 and 32 are shown secured to the body structure 40 of the vehicle 10, such as the bumper, fender, license plate mount and the like. The imaging devices may also be secured behind an optically transparent cover, and advantageously could be secured behind a turning signal, headlamp or other lens. The imaging devices 26 and 30 are arranged to view laterally of a first side 42 of the vehicle 10 into the lanes of traffic 20, and imaging devices 28 and 32 are arranged to view laterally of a second side 44 of the vehicle 10. The imaging devices 26-32 capture images of the environment lateral to the vehicle and from a forward perspective, further forward than the operator would normally be able to view based upon a customary driving position. The image data of the environment is feed to a monitor device to be viewed by the operator from within the vehicle. The imaging devices view may also encompass the forward or reverse direction of the vehicle. For example, by viewing laterally and rearwardly, the imaging devices may detect objects within what are typically referred to as the vehicle blind spots.

FIG. 2 illustrates a rear view mirror 50 including a mirror portion 52 flanked by monitor devices 54 and 56. The monitor devices may be liquid crystal displays, plasma displays or other similar devices for displaying image data. The monitor devices are respectively coupled to one or more imaging devices 26-32. For example, the monitor device 54 may be coupled to imaging device 26 while the monitor device 56 may be coupled to imaging device 28. A monitor device may be provided for each imaging device in one-to-one correspondence or, as illustrated in FIG. 2, fewer monitor devices may be provided than imaging devices and a selector, for example a selector button 58 and 60, respectively, for monitor devices 54 and 56, may be used to select the imaging device to be coupled to the monitor device at any moment. While the selector buttons 58 and 60 are shown located on the rear view mirror 50, it will be appreciated that the selector buttons may be located elsewhere in the vehicle, and for example on a steering wheel control. Additionally, a single selector button may be provided with a switch arrangement to allow the single button to respectively select the image for each of monitor devices 54 and 56.

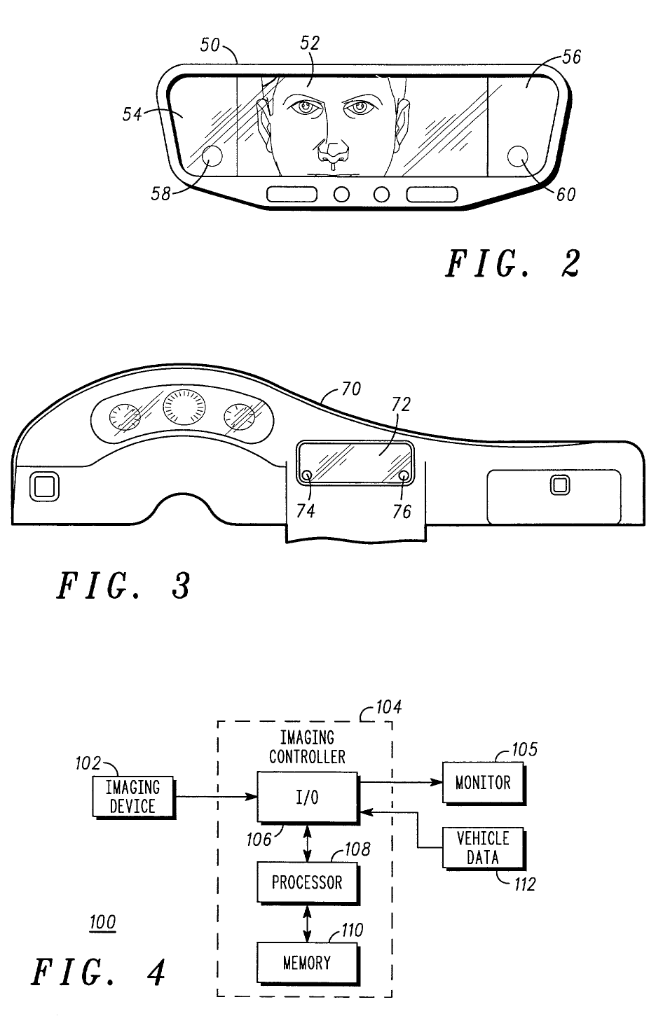

FIG. 3 illustrates an instrument panel 70 including a monitor device 72 and a selector button 74. The monitor device 72 may be selectively coupled to one or more of the imaging devices, such as imaging devices 26-32. Monitor device 72 may also include an indicator 76, shown in a lower right hand corner of the monitor device 72 although its location could be at any convenient location on monitor device 72 to indicate the imaging device currently coupled to the monitor device.

The monitor device, such as monitor devices 54 and 56 or monitor device 72 may be manually actuated, i.e., turned on, by a separate on/off button (not depicted) or by actuation of the selector buttons, 58, 60 and 74, respectively. Additionally, the monitor devices may be automatically activated upon activation of a turn signal indicator. Upon actuation of the turn signal indicator the monitor devices may display the images received from various imaging devices. The images displayed may be a result of the last selected imaging device selected by the user using the appropriate selector button, a preferred imaging device as established by user preference, or the imaging device selected to be coupled to the monitor device may be automatically selected.

The automatic selection of the imaging device may be based the direction the vehicle is moving and the turn signal indicator activated. Alternatively, the images may be obtained from each of the available imaging devices, and an image processing algorithm may be employed to determine the location of potential obstructions, oncoming traffic or other hazards based upon the received images and other vehicle conditions. From this data, the image providing the most relevant information to the upcoming maneuver may be selected and displayed.

Referring to FIG. 4, a system 100 includes operatively coupled an imaging device 102, an imaging controller 104 and a monitor device 106. The imaging device 102 may be one or more of the imaging devices such as imaging devices 26-32 and the monitor device may be one or more of the monitor devices 54, 56 and 72 as described herein. The imaging controller 104 includes operatively coupled an input/output interface 106, a processor 108 and a memory 110. The memory may contain a control program, including the image processing algorithm, for controlling operation of the processor 108. Alternatively, the processor 108 may be specifically designed and programmed to include the necessary control and object recognition algorithms, which may provide higher speed operation.

Image data is received from the imaging device 102 via the input/output interface 106 (it should be noted that the input/output interface while shown as a separate element may be integrated with the processor 108 as well may be the memory 110). The input/output interface 106 is also coupled to receive vehicle condition data 112, including turn signal indications, current direction of travel and acceleration, GPS or other data suggesting a change in the direction of travel. Given the image data and the vehicle condition data, the processor 108 processes the image data according to the image processing algorithm and identify the image providing the most useful information to the driver. For example, the algorithm may seek out images illustrating oncoming traffic, cyclists or pedestrians that may enter the vehicle's path should the maneuver be carried out.

Referring again to FIG. 1, the imaging devices 26 and 28 are shown respectively mounted to masts 36 and 38. Masts 36 and 38 may be fixed mounted masts, but may be retractable or telescoping to permit the imaging device to extend further forward of the vehicle to enhance its viewing angle. Providing retractable masts advantageously allows the imaging device to be retracted to a protected location except when in use. Additionally, the imaging device may be fitted with an iris, shutter or similar device to protect the lens of the imaging device when not in use. Still further, the self-cleaning lens system may be employed permitting dirt accumulation on the lens to be cleaned periodically or as directed by the vehicle operator. Such self-cleaning lens systems are well known and frequently used in connection with on-board camera devices used during motorcar racing events.

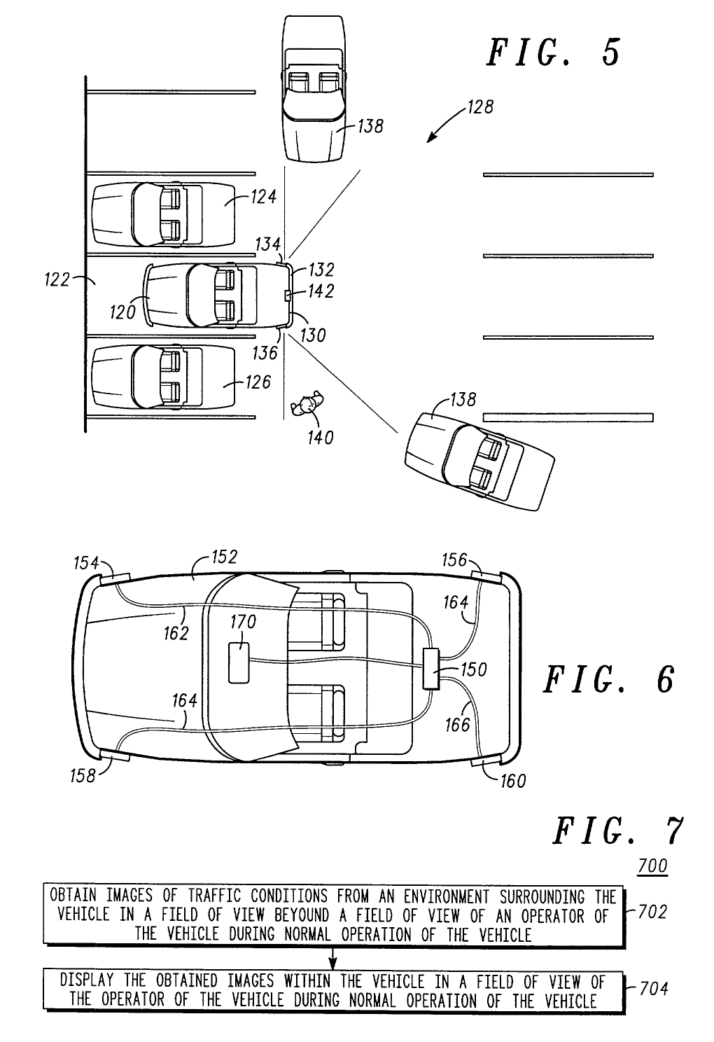

FIG. 5 illustrates a vehicle 120 backing from a parking space 122 flanked by vehicles 124 and 126 into an access lane 128. The rear portion 130, such as the rear bumper 132, includes imaging devices 134 and 136. The imaging devices are arranged to image laterally of the vehicle into the access lane, and the images are coupled to one or more monitor devices positioned within the vehicle to view oncoming vehicles 138 and pedestrian 140. As described, an image selection algorithm may be used to select the images from one or both of the imaging devices 134 and 136 (or additional imaging devices if the vehicle is so equipped. Additionally, the image selection processor may be adapted to operate in conjunction with an ultrasonic, radar or similar backing assist system for selecting the images to be displayed on the monitor devices. While the imaging devices 134 and 136 are shown secured to the body structure of the vehicle 120, they may be secured to fixed or retractable masts.

The imaging devices may be any suitable digital camera device as are well known. As opposed to providing several imaging devices, a single imaging device may be provided. FIG. 5 illustrates a centrally located imaging device 142 capable of viewing, either by using fixed optics or an adjustable mount, each side of the vehicle 120. FIG. 6 illustrates an alternate embodiment using a single imaging device, wherein the single imaging device is located at a protected location within the vehicle, and fiber optic cable and optical switches are used to allow the centrally located imaging device to gather image data from various locations on the vehicle. Referring to FIG. 6, an imaging device 150 is centrally located within the vehicle 152. Lens 154-160 are disposed at the corners of the vehicle and are coupled by fiber optic cable 162-168 to the imaging device 150. The imaging device 150 is further coupled to provide an output to a monitor device 170 positioned within the vehicle 152 and within view of the driver.

In the foregoing embodiments, the imaging devices have been generally described as having a fixed viewing angle relative to the vehicle. However, the imaging devices may be secured to adjustable mounting devices such that its viewing angle relative to a longitudinal axis of the vehicle may be changed. The viewing angle may be adjusted based on any number of parameters including vehicle speed, vehicle location relative to intersections merging traffic and the like (as determined by a navigation system) and straight line or turning travel direction. At speeds above a threshold speed, for example 10 miles per hour (mph), the imaging devices may be adjusted to view laterally of the vehicle for side collision avoidance such as on lane changing.

Referring to FIG. 7, a method 700 of viewing traffic conditions from within the vehicle is illustrated in flowchart form. 17. At step 702, images of traffic conditions are obtained from an environment surrounding the vehicle and in a field of view beyond a field of view of an operator of the vehicle during normal operation of the vehicle. At step 704, the obtained images are displayed within the vehicle.

In an alternate embodiment, the method may include the step of simultaneously obtaining a plurality of images of traffic conditions in an environment surrounding the vehicle and in fields of view beyond a field of view of the operator during normal operation of the vehicle. At least one of the images is selected from the plurality of images, and the selected image is displayed within the vehicle.

This patent describes several specific embodiments. However, one of ordinary skill in the art will appreciate that various modifications and changes can be made to these embodiments. Accordingly, the specification and drawings are to be regarded in an illustrative rather than restrictive sense, and all such modifications are intended to be included within the scope of the present patent.

We claim:

1. An apparatus for in-vehicle of viewing of traffic flow comprising:
an imaging device secured to a vehicle and having a field of view, the field of view extending beyond a field of view of an operator of the vehicle during normal operation of the vehicle;
a monitor device disposed on the vehicle and within a field of view of the operator of the vehicle during the operator's normal operation of the vehicle; and
wherein the imaging device is coupled to the monitor device for providing an image of traffic conditions within the field of view on the monitor device.

2. The apparatus of claim 1 comprising a plurality of imaging devices, each of the plurality of imaging devices having a field of view, each field of view extending beyond the field of view of the operator of the vehicle during normal operation of the vehicle and the each of the plurality of imaging devices being coupled to the monitor device and each of the plurality of imaging devices providing an image of traffic conditions within the respective field of view for display on the monitor device.

3. The apparatus of claim 2, comprising a selector coupled to the monitor for selecting an image from at least one of the plurality of imaging devices for display on the monitor device.

4. The apparatus of claim 1, comprising a mast secured to the vehicle and the imaging device being mounted to the mast.

5. The apparatus of claim 4, wherein the mast is either one of extendible and retractable.

6. The apparatus of claim 1, comprising a plurality of imaging devices, each of the plurality of imaging devices having a field of view, each field of view extending beyond the field of view of the operator of the vehicle during normal operation of the vehicle and the each of the plurality of imaging devices being coupled to the monitor device, each of the plurality of imaging devices providing an image of traffic conditions within the respective field of view for display on the monitor device and a processor coupled to each of the plurality of imaging devices and the monitor device, the processor being operable for selecting an image of traffic conditions from within one of the respective fields of view for display on the monitor device.

7. The apparatus of claim 1, wherein the imaging devices are mounted on one of a front portion of the vehicle and a rear portion of the vehicle.

8. The apparatus of claim 1, wherein the monitor device is mounted to one of a rear view mirror and an instrument panel within the vehicle.

9. The apparatus of claim 1, comprising a plurality of monitor devices.

10. The apparatus of claim 1, wherein the imaging device has an adjustable field of view.

11. The apparatus of claim 1, wherein the imaging has an adjustable field of view responsive to an operating condition of the vehicle.

12. An apparatus for in-vehicle viewing of traffic conditions comprising:
a plurality of imaging devices secured to an exterior of a vehicle, each of the plurality of imaging devices having a field of view extending beyond a field of view of an operator of the vehicle during normal operation of the vehicle;
at least one monitor device disposed within an interior of the vehicle and within a field of view of the operator of the vehicle during normal operation of the vehicle;
the plurality of imaging devices being coupled to the monitor device;
a selector couple to the plurality of imaging devices and the monitor device to select an image from a selected one of the plurality of imaging devices for display on the monitor device.

13. The apparatus of claim 12, wherein the selector comprises a button operated switch disposed within the interior of the vehicle.

14. The apparatus of claim 12, wherein the selector comprises a processor programmed to include an image selection algorithm to select the image for display on the monitor device.

15. The apparatus of claim 12, wherein at least one of the plurality of imaging devices is mounted on a mast.

16. The apparatus of claim 15, wherein the mast is at least one of extendible and retractable.

17. A method of viewing traffic conditions from within a vehicle, the method comprising the steps of:
obtaining an image of traffic conditions in an environment surrounding the vehicle and in a field of view beyond a field of view of an operator of the vehicle during normal operation of the vehicle;
displaying the image of traffic conditions within the vehicle and within a field of view of the operator during normal operation of the vehicle.

18. The method of claim 17, wherein the step of obtaining an image of traffic conditions comprises simultaneously obtaining a plurality of images of traffic conditions in an environment surrounding the vehicle and in fields of view beyond a field of view of the operator during normal operation of the vehicle;
selecting at least one of the images; and
wherein the step of displaying the image of traffic conditions comprises displaying the at least one of the images.

19. The method of claim 18, wherein the step of selecting comprises selecting based upon at least one operating condition of the vehicle.

20. The method of claim 17, comprising the step of adjusting the field of view from which the image of traffic conditions is obtained based upon an operating condition of the vehicle.
